(19) United States
(12) Patent Application Publication
(10) Pub. No.: US 2017/0083794 A1
(43) Pub. Date: Mar. 23, 2017

(54) VIRTUAL, ROAD-SURFACE-PERCEPTION TEST BED

(71) Applicant: Ford Global Technologies, LLC, Dearborn, MI (US)

(72) Inventors: Venkatapathi Raju Nallapa, Fairfield, CA (US); Martin Saeger, Pulheim (DE); Ashley Elizabeth Micks, Mountain View, CA (US); Douglas Blue, Plymouth, MI (US)

(21) Appl. No.: 14/858,671

(22) Filed: Sep. 18, 2015

(51) Int. Cl. G06K 9/62; G06N 99/00; G06K 9/00

(52) U.S. Cl. CPC G06K 9/6262; G06K 9/6256; G06K 9/00805; G06K 9/00825; G06K 9/00818; G06N 99/005

(57) ABSTRACT

A method for testing the performance of one or more anomaly-detection algorithms. The method may include obtaining sensor data output by a virtual sensor modeling the behavior of an image sensor. The sensor data may correspond to a time when the virtual sensor was sensing a virtual anomaly defined within a virtual road surface. One or more algorithms may be applied to the sensor data to produce at least one perceived dimension of the virtual anomaly. Thereafter, the performance of the one or more algorithms may be quantified by comparing the at least one perceived dimension to at least one actual dimension of the virtual anomaly as defined in the virtual road surface.

### BACKGROUND

Field of the Invention

This invention relates to vehicular systems and more particularly to systems and methods for developing, training, and proving algorithms for detecting anomalies in a driving environment.

Background of the Invention

To provide, enable, or support functionality such as driver assistance, controlling vehicle dynamics, and/or autonomous driving, well proven algorithms for interpreting sensor data are vital. Accordingly, what is needed is a system and method for developing, training, and proving such algorithms.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic diagram illustrating one embodiment of a simulation that may be performed by a system in accordance with the present invention;

FIG. 2 is a schematic diagram illustrating an alternative embodiment of a simulation that may be performed by a system in accordance with the present invention;

FIG. 3 is a schematic block diagram illustrating one embodiment of a system in accordance with the present invention;

FIG. 4 is a schematic diagram illustrating one embodiment of a virtual driving environment including anomalies in accordance with the present invention;

FIG. 5 is a schematic diagram illustrating a virtual vehicle at a first instant in time in which one or more virtual sensors are “viewing” a pothole located ahead of the vehicle;

FIG. 6 is a schematic diagram illustrating the virtual vehicle of FIG. 5 at a second, subsequent instant in time in which the vehicle is encountering (e.g., driving over) the pothole;

FIG. 7 is a schematic diagram illustrating one embodiment of sensor data tagged with one or more annotations in accordance with the present invention;

FIG. 8 is a schematic block diagram illustrating one embodiment of an annotation in accordance with the present invention;

FIG. 9 is a schematic block diagram of one embodiment of a method for generating training data in accordance with the present invention;

FIG. 10 is a schematic block diagram of one embodiment of a method for using training data in accordance with the present invention; and

FIG. 11 is a schematic block diagram of one embodiment of a method for generating training data and using that data in real time in accordance with the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

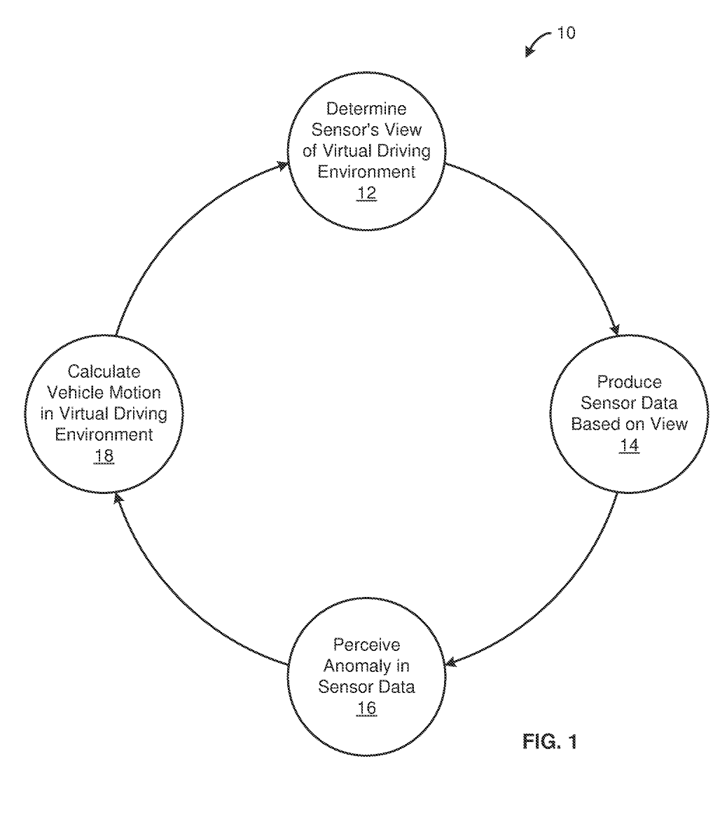

Referring to FIG. 1, the real world presents an array of conditions and obstacles that are ever changing. This reality creates significant challenges for vehicle-based systems providing autonomous control of certain vehicle dynamics and/or autonomous driving. To overcome these challenges, a vehicle may be equipped with sensors and computer systems that collectively sense, interpret, and appropriately react to a surrounding environment. Key components of such computer systems may be one or more algorithms used to interpret data output by various sensors carried on-board such vehicles.

For example, certain algorithms may analyze one or more streams of sensor data characterizing an area ahead of a vehicle and recognize when an anomaly is present in that area. Other algorithms may be responsible for deciding what to do when an anomaly is detected. To provide a proper response to such anomalies, all such algorithms must be well developed and thoroughly tested.

In selected embodiments, an initial and significant portion of the development and testing of various algorithms may be accomplished in a virtual environment. For example, at a particular moment within a computer-based simulation 10, a virtual sensor carried on-board a virtual vehicle may occupy a particular location within a virtual driving environment. Accordingly, at that moment, the virtual sensor's “view” of the virtual driving environment may be determined 12. This view may be processed through the virtual sensor in order to produce 14 sensor data (i.e., a modeled sensor output) based on the view.

Thereafter, one or more algorithms may be applied to the sensor data corresponding to the view. The algorithms may be programmed to search the sensor data for anomalies within the virtual driving environment. For example, if a view of the virtual sensor is directed to a portion of the virtual driving environment directly ahead of the virtual vehicle, then the one or more algorithms may analyze the sensor data in an effort to perceive 16 any anomalies in that area that may affect the operation or motion of the virtual vehicle.

As a simulation 10 moves forward or progresses, the virtual vehicle may advance some increment into the virtual driving environment. This motion may be calculated 18. Accordingly, the virtual sensor carried on-board a virtual vehicle may occupy a different location within a virtual driving environment. The virtual sensor's view of the virtual driving environment from this new location may be determined 12 and the simulation 10 may continue. In this manner, the ability of one or more algorithms to accurately and repeatably identify, characterize, and/or track various anomalies may be tested and improved.

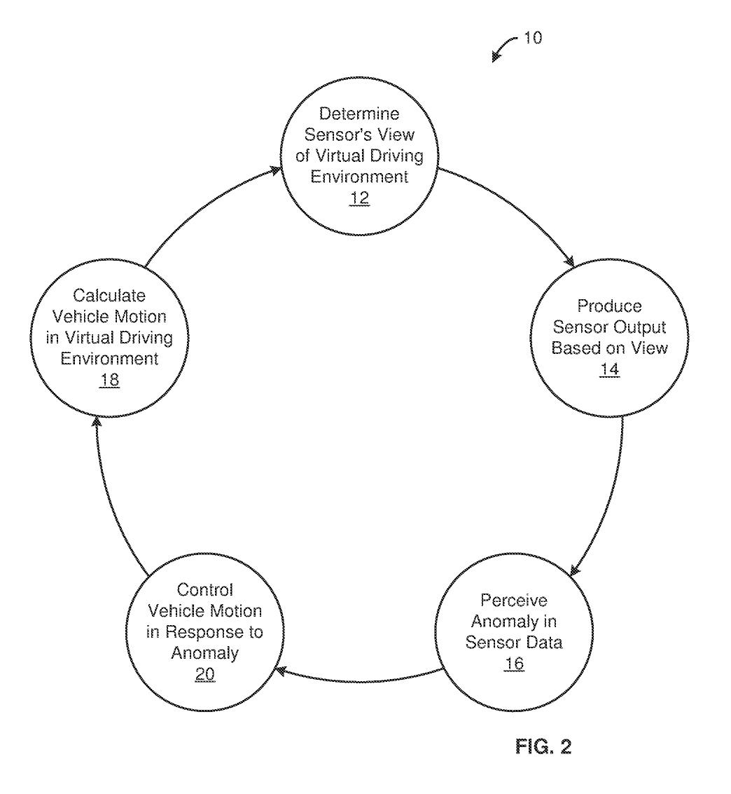

Referring to FIG. 2, in different simulations 10, different algorithms may be tested and improved. For example, as explained hereinabove, certain simulations 10 may provide a test bed for one or more algorithms directed at identifying, characterizing, and/or tracking various anomalies. Other simulations 10 may provide a test bed for one or more algorithms directed at controlling the motion or operation of a vehicle.

For example, after a virtual sensor's view of a virtual driving environment is determined 12 and used to produce 14 sensor data, one or more first algorithms may search for and perceive 16 one or more anomalies within the virtual driving environment. Accordingly, one or more second algorithms may be programmed to receive the characterizations output by the first algorithms and decided how best to react or respond thereto.

For example, depending on various factors (e.g., locations of surrounding vehicles or objects, speed of vehicle, positional attitude of vehicle, type of anomaly, size of anomaly, or the like), second algorithms may determine whether it is best to do nothing, brake, change suspension characteristics, lift a wheel, turn, change lanes, fade left or right within a lane, or the like to properly address the challenges presented by a perceived anomaly. Thus, one or more second algorithms may provided the logical basis for controlling 20 the operation or motion of a virtual vehicle in response to one or more perceived virtual anomalies.

As such a simulation 10 moves forward or progresses, the virtual vehicle may advance some increment into the virtual driving environment and the new position of the virtual vehicle may be calculated 18. Accordingly, the virtual sensor carried on-board a virtual vehicle may occupy a different location within a virtual driving environment. The virtual sensor's view of the virtual driving environment from this new location may be determined 12 and the simulation 10 may continue. In this manner, the ability of one or more algorithms to identify appropriate responses to various anomalies may be tested and improved.

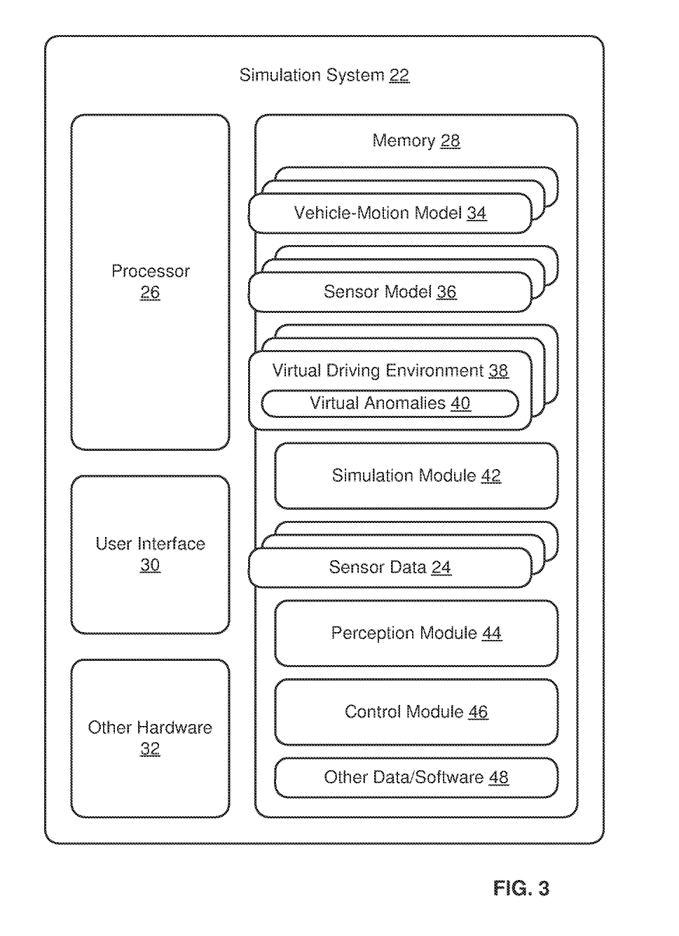

Referring to FIG. 3, in selected embodiments, a system 22 in accordance with the present invention may provide a test bed for developing, testing, and/or training various algorithms. For example, in certain embodiments, a system 22 may execute one or more simulations 10 in order to produce sensor data 24. A system 22 may also use that sensor data 24 (e.g., run one or more other simulations 10) to develop, test, and/or train various algorithms (e.g., anomaly-detection algorithms, anomaly-response algorithms, or the like). In so doing, a system 22 may operate on or analyze the sensor data 24 in real time (i.e., as it is produced) or sometime after the fact. A system 22 may accomplish these functions in any suitable manner. For example, a system 22 may be embodied as hardware, software, or some combination thereof.

In selected embodiments, a system 22 may include computer hardware and computer software. The computer hardware of a system 22 may include one or more processors 26, memory 28, a user interface 30, other hardware 32, or the like or a combination or sub-combination thereof. The memory 28 may be operably connected to the one or more processors 26 and store the computer software. This may enable the one or more processors 26 to execute the computer software.

A user interface 30 of a system 22 may enable an engineer, technician, or the like to interact with, run, customize, or control various aspects of a system 22. In selected embodiments, a user interface 30 of a system 22 may include one or more keypads, keyboards, touch screens, pointing devices, or the like or a combination or sub-combination thereof.

In selected embodiments, the memory 28 of a system 22 may store one or more vehicle-motion models 34, one or more sensor models 36, one or more virtual driving environments 38 containing various virtual anomalies 40, a simulation module 42, sensor data 24, a perception module 44, a control module 46, other data or software 48, or the like or combinations or sub-combinations thereof.

A vehicle-motion model 34 may be a software model that may define for certain situations the motion of the body of a corresponding vehicle. In certain embodiments, a vehicle-motion model 34 may be provided with one or more driver inputs (e.g., one or more values characterizing things such as velocity, drive torque, brake actuation, steering input, or the like or combinations or sub-combinations thereof) and information (e.g., data from a virtual driving environment 38) characterizing a road surface. With these inputs and information, a vehicle-motion model 34 may predict motion states of the body of a corresponding vehicle.

The parameters of a vehicle-motion model 34 may be determined or specified in any suitable manner. In selected embodiments, certain parameters of a vehicle-motion model 34 may be derived from previous knowledge of the mechanical properties (e.g., geometries, inertia, stiffness, damping coefficients, etc.) of a corresponding real-world vehicle.

As appreciated, the parameters may be different for different vehicles. Accordingly, in selected embodiments, a vehicle-motion model 34 may be vehicle specific. That is, one vehicle-motion model 34 may be suited to model the body dynamics of a first vehicle (e.g., a particular sports car), while another vehicle-motion model 34 may be suited to model the body dynamics of a second vehicle (e.g., a particular pickup truck).

A sensor model 36 may be a software model that may define or predict for certain situations or views the output of a corresponding real-world sensor. Accordingly, a sensor model 36 may form the computational heart of a virtual sensor. In certain embodiments, a sensor model 36 may be provided with information (e.g., data from a virtual driving environment 38) characterizing various views of a road surface. With this information, a sensor model 36 may predict what an actual sensor presented with those views in the real world would output. In certain embodiments, a sensor model 36 may include signal processing code such as SIMULINK models or independent C++ code to access and process data from a virtual driving environment 38 as needed so that it reflects the limitations of the sensor to be modeled.

In selected embodiments, real world sensors of interest may comprise transducers that sense or detect some characteristic of an environment and provide a corresponding output (e.g., an electrical or optical signal) that defines that characteristic. For example, one or more real world sensors of interest may be accelerometers that output an electrical signal characteristic of the proper acceleration being experienced thereby. Such accelerometers may be used to determine the orientation, acceleration, velocity, and/or distance traveled by a vehicle. Other real world sensors of interest may include cameras, laser scanners, lidar scanners, radar devices, gyroscopes, inertial measurement units, revolution counters or sensors, strain gauges, temperature sensors, or the like or other sensors that can be modeled in a virtual environment.

A sensor model 36 may model the output produced by any real world sensor of interest. As appreciated, the outputs may be different for different real world sensors. Accordingly, in selected embodiments, a sensor model 36 may be sensor specific. That is, one sensor model 36 may be suited to model the output of a first sensor (e.g., a particular camera), while another sensor model 36 may be suited to model the output of a second sensor (e.g., a particular laser scanner).

In selected embodiments, one or more sensor models 36 may model image sensors. An image sensor may be a sensor that detects and conveys information that constitutes an image. Image sensors may include cameras, laser scanners, lidar scanners, radar devices, and the like or other image sensors that can be modeled in a virtual environment.

A sensor model 36 may produce an output of any suitable format. For example, in selected embodiments, a sensor model 36 may output a signal (e.g., analog signal) that a corresponding real-world sensor would produce. Alternatively, a sensor model 36 may output a processed signal. For example, a sensor model 36 may output a processed signal such as that output by a data acquisition system. Accordingly, in selected embodiments, the output of a sensor model 36 may be a conditioned, digital version of the signal that a corresponding real-world sensor would produce.

A simulation module 42 may be programmed to use a virtual driving environment 38, a vehicle-motion model 34, and one or more sensor models 36 to produce an output (e.g., sensor data 24) modeling what would be output by one or more corresponding real world sensors had the one or more real world sensors been mounted to a vehicle (e.g., the vehicle modeled by the vehicle-motion model 34) driven on an actual driving environment like (e.g., substantially or exactly matching) the virtual driving environment 38.

A perception module 44 may be programmed to apply, test, and/or improve one or more anomaly-detection algorithms. For example, in selected embodiments, a perception module 44 may apply one or more anomaly-detection algorithms to certain sensor data 24 in order to produce one or more perceived dimensions of one or more virtual anomalies 40. Perceived dimensions may include the length, width, thickness, depth, height, and/or orientation of an anomaly 40. Perceived dimensions may also include distance from a vehicle to an anomaly 40, distance from a center line (e.g., a line where a middle of a vehicle will pass given current steering inputs) to an anomaly 40, or the like or combinations thereof.

Thereafter, a perception module 44 may quantify a performance of the one or more anomaly-detection algorithms by comparing the one or more perceived dimensions to one or more actual dimensions of the one or more virtual anomalies 40 as defined in the virtual driving environment 38. The actual dimensions of the one or more virtual anomalies 40 may be the “ground truth.” That is, the exact dimensions corresponding to the perceived dimensions may be known from the virtual driving environment 38. Accordingly, in selected embodiments, a perception module 44 may use sensor data 24, ground truth data, and supervised learning techniques to improve the performance of the one or more anomaly-detection algorithms.

In selected embodiments, one or more anomalies 40 as perceived by one or more anomaly-detection algorithms may be displayed using markings and labels so as to overlay on a simulation window the virtual sensor's point of view. Alternatively, or in addition thereto, an output of one or more anomaly-detection algorithms may be time stamped and written to a file for later study.

In certain embodiments, one or more anomaly-detection algorithms may be or comprise one or more neural networks trained to recognize features in sensor data 24 (e.g., camera data) as indicative of a pothole, speed bump, or other anomaly 40. An anomaly-detection algorithm may be in need of improvement if one or more tests indicate that the anomaly-detection algorithm is getting certain false positives or false negatives. The improvement to such an anomaly-detection algorithm may be made through additional training of the neural network. The additional training may involve or utilize training data covering the cases where the anomaly-detection algorithm had trouble. In other embodiments, where other types of anomaly-detection algorithms are used, those algorithms may be improved by tuning certain parameters according to the test results.

A control module 46 may be programmed to apply, test, and/or improve one or more anomaly-response algorithms. For example, a control module 46 may apply one or more anomaly-response algorithms to certain dimensions output by one or more anomaly-detection algorithms. The one or more anomaly-response algorithms may determine how to respond to one or more anomalies 40 based on the dimensions thereof.

For example, if the dimensions output by one or more anomaly-detection algorithms indicate that a particular anomaly 40 is a manhole cover, one or more anomaly-response algorithms may determine that no response is needed. Conversely, if the dimensions output by one or more anomaly-detection algorithms indicate that a particular anomaly 40 is a pothole, one or more anomaly-response algorithms may determine that certain steering inputs are needed in order to avoid driving any wheel through the pothole.

In selected embodiments, one or more response algorithms may be or comprise path-planning and/or path-following algorithms that navigate around potholes, algorithms that adjust vehicle speed and/or suspension according to the roughness of the terrain, algorithms that issue one or more alerts to the driver (e.g., if the vehicle is going too fast for an oncoming speed bump, etc), or the like or combinations or sub-combinations thereof.

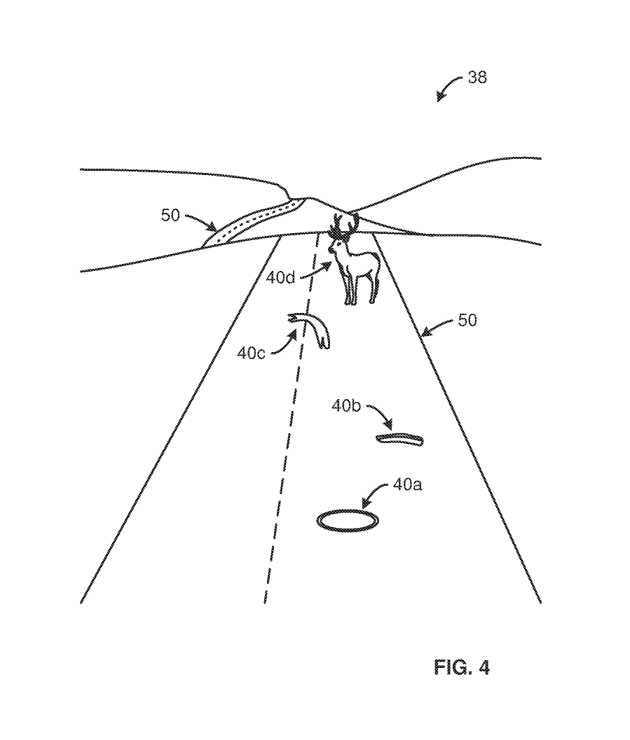

Referring to FIG. 4, in selected embodiments, a virtual driving environment 38 may comprise a three dimensional mesh defining, in a virtual space, a driving surface 50 (e.g., road) and various anomalies 40 distributed (e.g., randomly distributed) across the driving surface 50. The anomalies 40 in a virtual driving environment 38 may model features or objects that intermittently or irregularly affect the operation of vehicles in the real world. Anomalies 40 included within a virtual driving environment 38 may be of different types.

For example, certain anomalies 40a may model features that are typically intentionally included within real world driving surfaces. These anomalies 40a may include manholes and manhole covers, speed bumps, gutters, lines or text painted onto or otherwise adhered to a driving surface 50, road signs, traffic lights, crack sealant, seams in paving material, changes in paving material, and the like. Other anomalies 40b may model defects in a driving surface 50. These anomalies 40b may include potholes, cracks, frost heaves, ruts, washboard surfaces, and the like. Other anomalies 40c may model inanimate objects resting on a driving surface 50. These anomalies 40c may include road kill, pieces of delaminated tire tread, trash, debris, fallen vegetation, or the like.

Still other anomalies 40d may model animate objects. Animate objects may be things in the real world that change their position with respect to a driving surface 50 over a relatively short period of time. Examples of animate objects may include animals, pedestrians, cyclists, other vehicles, tumbleweeds, or the like. In selected embodiments, anomalies 40d that model animate objects may be included within a virtual driving environment 38 in an inanimate form. That is, they may be stationary within the virtual driving environment 38. Alternatively, anomalies 40d that model animate objects may be included within a virtual driving environment 38 in an animate form and may move within that environment 38. This may enable sensor data 24 in accordance with the present invention to be used in developing, training, or the like algorithms for tracking various anomalies 40.

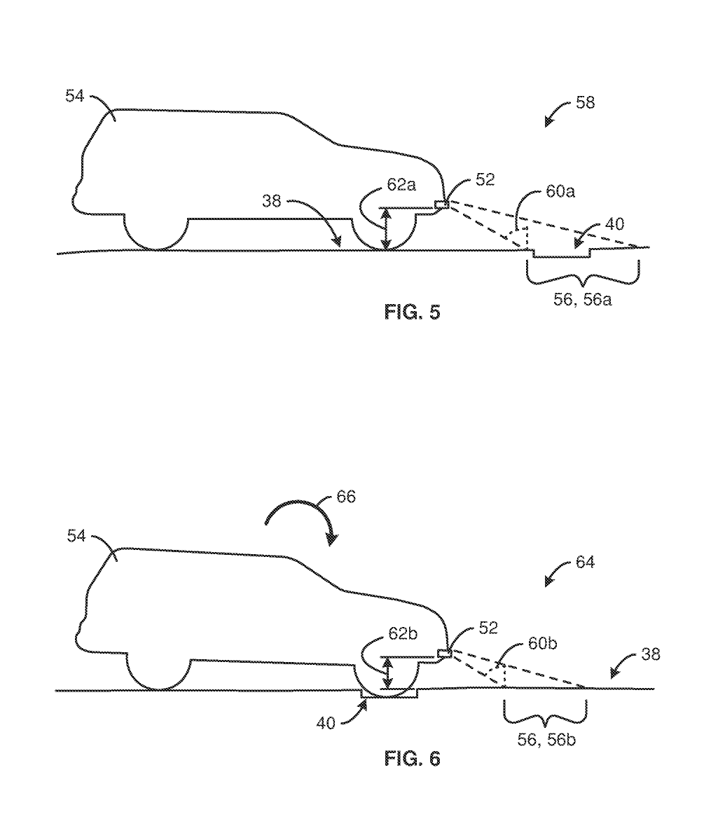

Referring to FIGS. 5 and 6, through a series of calculations, a simulation module 42 may effectively traverse one or more virtual sensors 52 over a virtual driving environment 38 (e.g., a road surface 50 of a virtual driving environment 38) defining or including a plurality of virtual anomalies 40 that are each sensible by the one or more virtual sensors 52. In selected embodiments, this may include manipulating during such a traverse a point of view of the one or more virtual sensors 52 with respect to the virtual driving environment 38. More specifically, it may include moving during such a traverse each of the one or more virtual sensors 52 with respect to the virtual driving environment 38 as dictated by a vehicle-motion model 34 modeling motion of a corresponding virtual vehicle 54 driving in the virtual driving environment 38 while carrying the one or more virtual sensors 52.

In selected embodiments, to properly account for the motion of the one or more virtual sensors 52, a simulation module 42 may take into consideration three coordinate systems. The first may be a global, inertial coordinate system within a virtual driving environment 38. The second may be an undisturbed coordinate system of a virtual vehicle 54 defined by or corresponding to a vehicle-motion model 34. This may be the coordinate system of an “undisturbed” version of the virtual vehicle 54, which may be defined as having its “xy” plane parallel to a ground plane (e.g., an estimated, virtual ground plane). The third may be a disturbed coordinate system of the vehicle 54. This may be the coordinate system of the virtual vehicle 54 performing roll, pitch, heave, and yaw motions which can be driver-induced (e.g., caused by virtualized steering, braking, accelerating, or the like) or road-induced (e.g., caused by a virtual driving environment 38 or certain virtual anomalies 40 therewithin) or due to other virtual disturbances (e.g., side wind or the like). A simulation module 42 may use two or more of these various coordinate systems to determine which views 56 or scenes 56 pertain to which virtual sensors 52 during a simulation process.

That is, in the real world, the sensors modeled by one or more sensor models 36 may be carried on-board a corresponding vehicle. Certain such sensors may be secured to move with the body of a corresponding vehicle. Accordingly, the view or scene surveyed by sensors such as cameras, laser scanners, radars, or the like may change depending on the orientation of the corresponding vehicle with respect to the surrounding environment. For example, if a vehicle rides over a bumpy road, a forward-looking image sensor (e.g., a vehicle-mounted camera, laser sensor, or the like monitoring the road surface ahead of the vehicle) may register or sense the same portion of road at different angles, depending on the current motion state of the vehicle.

To simulate such effects in a system 22 in accordance with the present invention, a simulation module 42 may take into consideration the location and orientation of one or more virtual sensors 52 (e.g., sensors being modeled by one or more corresponding sensor models 36) within a coordinate system corresponding to the virtual vehicle 54 (e.g., the vehicle being modeled by the vehicle-motion model 34). A simulation module 42 may also take into consideration how such a vehicle-based coordinate system is disturbed in the form of roll, pitch, heave, and yaw motions predicted by a vehicle-motion model 34 based on virtualized driver inputs, road inputs defined by a virtual driving environment 38, and the like. Accordingly, for any simulated moment in time that is of interest, a simulation module 42 may calculate a location and orientation of a particular virtual sensor 52 with respect to a virtual driving environment 38 and determine the view 56 within the virtual driving environment 38 to be sensed at that moment by that particular virtual sensor 52.

For example, in a first simulated instant 58, a forward-looking virtual sensor 52 may have a particular view 56a of a virtual driving environment 38. In selected embodiments, this view 56a may be characterized as having a first angle of incidence 60a with respect to the virtual driving environment 38 and a first spacing 62a in the normal direction from the virtual driving environment 38. In the illustrated embodiment, this particular view 56a encompasses a particular anomaly 40, namely a pothole.

However, in a second, subsequent simulated instant 64, a virtual vehicle 54 may have pitched forward 66 due to modeled effects associated with driving through the previously viewed virtual anomaly 40 (i.e., pothole). Accordingly, in the second instant 64, the forward-looking sensor 52 may have a different view 56b of a virtual driving environment 38. Due to the pitching forward 66, this view 56b may be characterized as having a second, lesser angle of incidence 60b with respect to the virtual driving environment 38 and a second, lesser spacing 62b in the normal direction from the virtual driving environment 38.

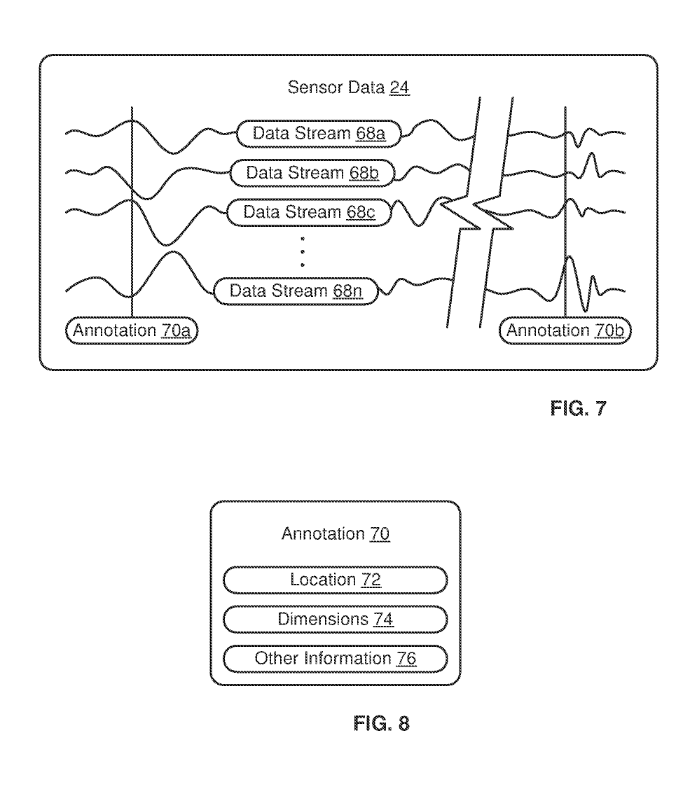

Referring to FIGS. 7 and 8, for a first simulated moment in time, a simulation module 42 may determine the view 56 of the virtual driving environment 38 to be sensed at that moment by a particular virtual sensor 52. A simulation module 42 may then obtain from an appropriate sensor model 36 an output that characterizes that view 56. This process may be repeated for a second simulated moment in time, a third simulated moment in time, and so forth. Accordingly, by advancing from one moment in time to the next, a simulation module 42 may obtain a data stream 68 modeling what would be the output of the particular virtual sensor 52 had it and the corresponding virtual driving environment 38 been real.

This process may be repeated for all of the virtual sensors 52 corresponding to a particular virtual vehicle 54. Accordingly, for the particular virtual vehicle 54 and the virtual driving environment 38 that is traversed, sensor data 24 comprising one or more data streams 68 may be produced.

In selected embodiments, different data streams 68 may represent the output of different virtual sensors 52. For example, a first data stream 68a may represent the output of a first virtual camera mounted on the front-right portion of a virtual vehicle 54, while a second data stream 68b may represent the output of a second virtual camera mounted on the front-left of the virtual vehicle 54. Collectively, the various data streams 68 forming the sensor data 24 for a particular run (e.g., a particular virtual traverse of a particular virtual vehicle 54 through a particular virtual driving environment 38) may represent or account for all the inputs that a particular algorithm (i.e., the anomaly-detection or anomaly-response algorithm that is being developed or tested) would use in the real world.

In certain embodiments or situations, a simulation module 42 may couple sensor data 24 with one or more annotations 70. Each such annotation 70 may provide “ground truth” corresponding to the virtual driving environment 38. In selected embodiments, the ground truth contained in one or more annotations 70 may be used to quantify an anomaly-detection algorithm's performance in classifying anomalies 40 in a supervised learning technique.

For example, one or more annotations 70 may provide true (e.g., exact) locations 72, true (e.g., exact) dimensions 74, other information 76, or the like or combinations thereof corresponding to the various anomalies 40 encountered by a virtual vehicle 54 in a particular run. Annotations 70 may be linked, tied to, or otherwise associated with particular portions of the data streams 68. Accordingly, the ground truth corresponding to a particular anomaly 40 may be linked to the portion of one or more data streams 68 that reflect the perception of one or more virtual sensors 52 of that anomaly 40. In selected embodiments, this may be accomplished by linking different annotations 70a, 70b to different portions of one or more data streams 68.

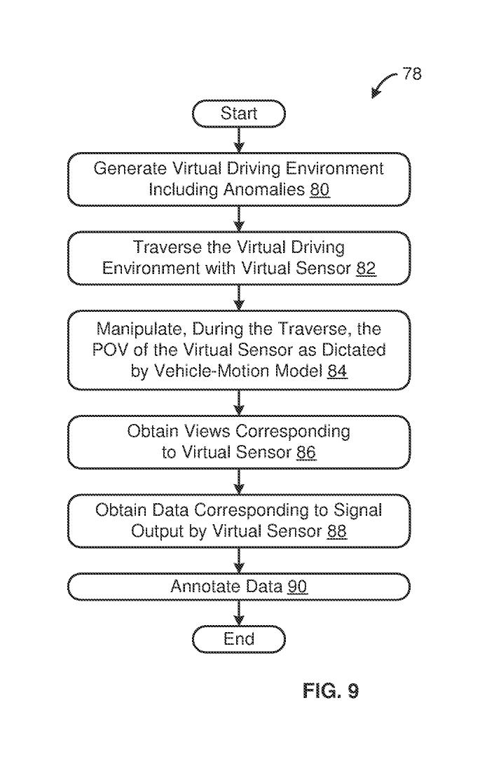

Referring to FIG. 9, a system 22 may support, enable, or execute a process 78 in accordance with the present invention. In selected embodiments, such a process 78 may begin with generating 80 a virtual driving environment 38 including various anomalies 40. The virtual driving environment 38 may then by traversed 82 in a simulation process with one or more virtual sensors 52.

As the virtual driving environment 38 is traversed 82 with one or more virtual sensors 52, the point of view of the one or more virtual sensor 52 onto the virtual driving environment 38 may be manipulated 84 as dictated by a vehicle-motion model 34. Accordingly, the various views 56 corresponding to the one or more virtual sensors 52 at various simulated moments in time may be obtained 86 or identified 86. The various views 56 thus obtained 86 or identified 86 may be analyzed by or via corresponding sensor models 36 in order to obtain 88 data 24 reflecting what a corresponding real sensor viewing the various views 56 in the real world would have produced or output. In selected embodiments, this data 24 may be annotated 90 with ground truth information to support or enable certain supervised learning techniques.

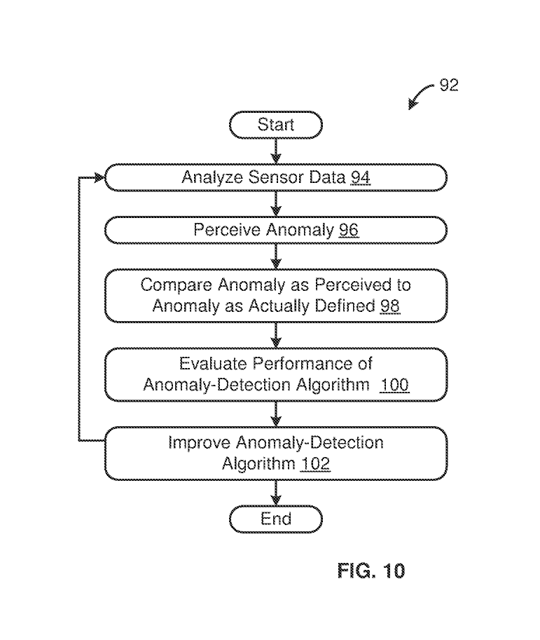

Referring to FIG. 10, once sensor data 24 (e.g., training data) has been produced in a first process 78, that data 24 may be used to develop, test, and/or improve one or more algorithms in a second process 92. For example, the sensor data 24 may be analyzed 94 by having one or more anomaly-detection algorithms applied thereto. Based on this analysis 94, one or more anomalies 40 may be perceived 96.

This perceiving 96 of the one or more anomalies 40 may include estimating certain dimensions or distances associated with the one or more anomalies 40. The estimated or perceived dimensions or distances may be compared 98 to the actual dimensions or distances, which are exactly known from the corresponding virtual driving environment 38. Accordingly, the performance of one or more anomaly-detection algorithms may be evaluated 100. In selected embodiments, this evaluating 100 may enable or support improvement 102 of one or more anomaly-detection algorithms.

In selected embodiments, a process 92 in accordance with the present invention may be repeated with the exact same sensor data 24. This may enable a developer to determine whether certain anomaly-detection algorithms are better than others. Alternatively, or in addition thereto, a process 92 may be repeated with different sensor data 24. Accordingly, the development, testing, and/or improvement of one or more anomaly-detection algorithms may continue as long as necessary.

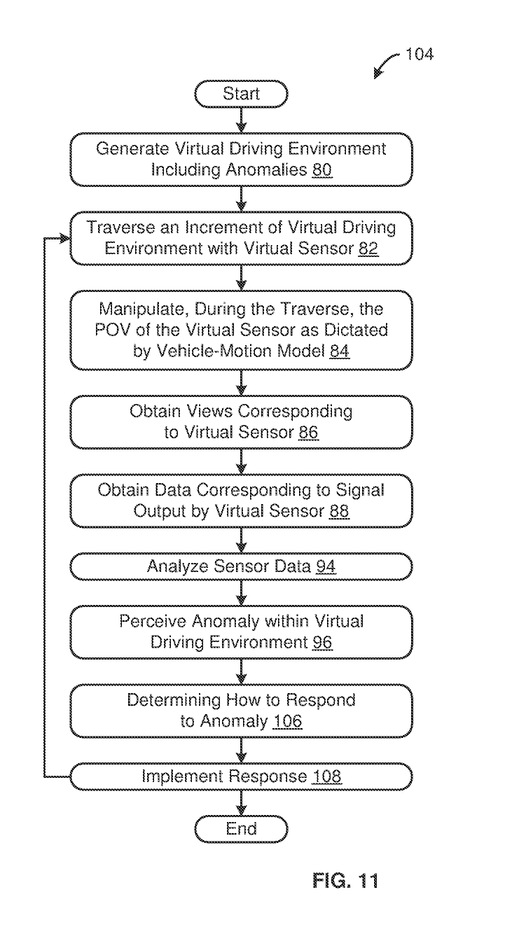

Referring to FIG. 11, in certain embodiments, sensor data 24 may be developed in a first process 78, stored for some period of time, and then used to develop, test, and/or improve one or more algorithms in a second, subsequent process 92. In other embodiments and processes 104, however, the production of sensor data 24 and the application of one or more algorithms may occur together in real time. Accordingly, in such embodiments and processes 104, a system 22 in accordance with the present invention may more completely replicate the events and time constraints associated with real world use of the corresponding algorithms.

In selected embodiments, a real time process 104 may begin with generating 80 a virtual driving environment 38 including various anomalies 40. One increment (e.g., a very small increment) of the virtual driving environment 38 may then by traversed 82 in a simulation process with one or more virtual sensors 52. As the increment of the virtual driving environment 38 is traversed 82 with one or more virtual sensors 52, the point of view of the one or more virtual sensor 52 onto the virtual driving environment 38 may be manipulated 84 as dictated by a vehicle-motion model 34. Accordingly, the various views 56 corresponding to the one or more virtual sensors 52 at the simulated moment in time may be obtained 86 or identified 86.

The various views 56 thus obtained 86 or identified 86 may be analyzed by or via corresponding sensor models 36 in order to obtain 88 data 24 reflecting what a corresponding real sensor viewing the various views 56 in the real world would have produced or output. In selected embodiments, this data 24 may be annotated 90 with ground truth information to support or enable certain supervised learning techniques.

Once sensor data 24 (e.g., training data) has been produced for a particular increment, that data 24 may be used to develop, test, and/or improve one or more algorithms. For example, the sensor data 24 may be analyzed 94 by having one or more anomaly-detection algorithms applied thereto. Based on this analysis 94, one or more anomalies 40 may be perceived 96. This perceiving 96 of the one or more anomalies 40 may include estimating certain dimensions or distances associated with the one or more anomalies 40. Thereafter, one or more anomaly-response algorithms may use these estimated dimensions or distances to determine 106 how to respond to the perceived 96 anomalies 40. The response so determined 106, may then be implemented 108.

The process 104 may continue as a virtual sensor 52 traverses 82 the next increment of a virtual driving environment 38. Thus, increment by increment, sensor data 24 may be obtained 88 and used. Moreover, the implementation 108 of a response may affect how a virtual sensor 52 traverses 82 the next increment of a virtual driving environment 38. Accordingly, a process 104 in accordance with the present invention may be adaptive (i.e., changes to the algorithms may result in changes in how the virtual vehicle 58 moves through a virtual driving environment 38 and/or in the path the virtual vehicle 58 takes through the virtual driving environment 38).

In selected embodiments, a process 104 in accordance with the present invention may be repeated with the exact same virtual driving environment 38. This may enable a developer to determine whether certain anomaly-detection and/or anomaly-response algorithms are better than others. Accordingly, a system 22 in accordance with the present invention may provide a test bed for developing, testing, and/or improving one or more anomaly-detection and/or anomaly-response algorithms.

The flowcharts in FIGS. 9-11 illustrate the architecture, functionality, and operation of possible implementations of systems, methods, and computer-program products according to various embodiments in accordance with the present invention. In this regard, each block in the flowcharts may represent a module, segment, or portion of code, which comprises one or more executable instructions for implementing the specified logical function(s). It will also be noted that each block of the flowchart illustrations, and combinations of blocks in the flowchart illustrations, may be implemented by special purpose hardware-based systems that perform the specified functions or acts, or combinations of special purpose hardware and computer instructions.

It should also be noted that, in some alternative implementations, the functions noted in the blocks may occur out of the order noted in the Figures. In certain embodiments, two blocks shown in succession may, in fact, be executed substantially concurrently, or the blocks may sometimes be executed in the reverse order, depending upon the functionality involved. Alternatively, certain steps or functions may be omitted if not needed.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A method comprising:
obtaining, by a computer system, sensor data output by a virtual sensor modeling the behavior of an image sensor while the virtual sensor is sensing a virtual anomaly defined within a virtual road surface;
producing, by one or more algorithms applied by the computer system to the sensor data, at least one perceived dimension of the virtual anomaly; and
quantifying, by the computer system, performance of the one or more algorithms by comparing the at least one perceived dimension to at least one actual dimension of the virtual anomaly as defined in the virtual road surface.

2. The method of claim 1, wherein the image sensor is selected from the group consisting of a camera, a laser scanner, and a radar device.

3. The method of claim 2, further comprising obtaining, by the computer system, ground truth data comprising the at least one actual dimension.

4. The method of claim 3, further comprising using, by the computer system, the sensor data, the ground truth data, and supervised learning techniques to improve the performance of the one or more algorithms.

5. The method of claim 4, wherein the virtual anomaly is selected from the group consisting of a virtual pot hole, a virtual speed bump, a virtual manhole cover, and virtual rough terrain.

6. The method of claim 1, wherein the obtaining the sensor data comprises:
traversing, by the computer system, the virtual sensor over the virtual road surface in a simulation;
manipulating, by the computer system during the traversing, a point of view of the virtual sensor with respect to the virtual road surface; and
recording, by the computer system, the sensor data as it is output by the virtual sensor during the traversing.

7. The method of claim 6, wherein the manipulating comprises changing an angle of incidence of the virtual sensor with respect to the virtual road surface.

8. The method of claim 7, wherein the manipulating further comprises changing a spacing in a normal direction between the virtual road surface and the virtual sensor.

9. The method of claim 8, wherein the manipulating further comprises moving the virtual sensor with respect to the virtual road surface as dictated by a vehicle-motion model modeling motion of a vehicle carrying the virtual sensor and driving on the virtual road surface.

10. The method of claim 9, wherein the image sensor is selected from the group consisting of a camera, a laser scanner, and a radar device.

11. The method of claim 10, further comprising obtaining, by the computer system, ground truth data comprising the at least one actual dimension.

12. The method of claim 11, further comprising using, by the computer system, the sensor data, the ground truth data, and supervised learning techniques to improve the performance of the one or more algorithms.

13. The method of claim 12, wherein the virtual anomaly is selected from the group consisting of a virtual pot hole, a virtual speed bump, a virtual manhole cover, and virtual rough terrain.

14. A method for testing the performance of one or more anomaly-detection algorithms, the method comprising:
obtaining, by a computer system, sensor data output by a virtual sensor modeling the behavior of an image sensor while the virtual sensor is sensing a virtual anomaly defined within a virtual road surface;
producing, by one or more algorithms applied by the computer system to the sensor data, at least one perceived dimension of the virtual anomaly;
obtaining, by a computer system, ground truth data defining exact dimensions of the virtual anomaly as defined within the virtual road surface;
quantifying, by the computer system, performance of the one or more algorithms by comparing the at least one perceived dimension to at least one actual dimension of the exact dimensions.

15. The method of claim 14, wherein the obtaining the sensor data comprises:
executing, by a computer system, a simulation comprising
traversing the virtual sensor over the virtual road surface, and
moving, during the traversing, the virtual sensor with respect to the virtual road surface as dictated by a vehicle-motion model modeling motion of a vehicle driving on the virtual road surface while carrying the virtual sensor; and
recording, by the computer system, the sensor data as it is output by the virtual sensor during the traversing.

16. The method of claim 15, wherein the moving comprises:
changing an angle of incidence of the virtual sensor with respect to the virtual road surface; and
changing a spacing in a normal direction between the virtual road surface and the virtual sensor.

17. The method of claim 16, wherein the image sensor is selected from the group consisting of a camera, a laser scanner, and a radar device.

18. The method of claim 17, further comprising using, by the computer system, the sensor data, the ground truth data, and supervised learning techniques to improve the performance of the one or more algorithms.

19. The method of claim 18, wherein the virtual anomaly is selected from the group consisting of a virtual pot hole, a virtual speed bump, a virtual manhole cover, and virtual rough terrain.

20. A computer system comprising:
one or more processors;
memory operably connected to the one or more processors; and
the memory storing
a virtual driving environment programmed to include a plurality of virtual anomalies,
a first software model programmed to model a sensor,
a second software model programmed to model a vehicle,
a simulation module programmed to use the virtual driving environment, the first software model, and the second software model to produce an output modeling what would be output by the sensor had the sensor been mounted to the vehicle and the vehicle had driven on an actual driving environment matching the virtual driving environment, and
a perception module programmed to apply one or more algorithms to the output to produce perceived dimensions characterizing each virtual anomaly of the plurality of virtual anomalies.

21. A method comprising:
obtaining, by a computer system, sensor data output by a virtual sensor sensing a virtual anomaly in a virtual driving environment;
producing, by an algorithm applied by the computer system to the sensor data, a perceived dimension of the virtual anomaly; and
quantifying, by the computer system, performance of the algorithm by comparing the perceived dimension to an actual dimension of the virtual anomaly as defined in the virtual driving environment.
